(19) United States
(12) Patent Application Publication
(10) Pub. No.: US 2018/0223868 A1
(43) Pub. Date: Aug. 9, 2018

(54) Turbine Engine Compressor with Variable-Pitch Vanes

(71) Applicant: Safran Aero Boosters SA, Herstal (BE)

(72) Inventor: Frédéric Vallino, Seraing (BE)

(73) Assignee: Safran Aero Boosters SA, Herstal (BE)

(21) Appl. No.: 15/892,607

(22) Filed: Feb. 9, 2018

(30) Foreign Application Priority Data
Feb. 9, 2017 (BE) 2017/5084

(51) Int. Cl. F04D 29/56; F02C 7/04; F02K 3/06; F16H 55/17; F16H 1/08

(52) U.S. Cl. CPC F04D 29/563; F02C 7/04; F02K 3/06; F05D 2260/532; F16H 1/08; F05D 2220/32; F16H 55/17

(57) ABSTRACT

A variable-geometry turbine engine compressor, in particular a low-pressure turboreactor compressor, which is also called a booster, includes: an annular row of variable stator vanes, each of the vanes including a control gearing, and an synchronizing ring with an additional gearing which cooperates with the control gearing of the vanes, so as to control the effect with respect to the flow of the turbine engine. Each gearing of the vane or of the ring is a herringbone gearing, the teeth of a herringbone of which form between them an angle β of between 60° and 150° inclusive, or possibly equal to 120°.

This application claims priority under 35 U.S.C. § 119 to Belgium Patent Application No. 2017/5084, filed 9 Feb. 2017, titled “Turbine Engine Compressor with Variable-Pitch Vanes,” which is incorporated herein by reference for all purposes.

### BACKGROUND

### 1. Field of the Application

The present application relates to the field of turbine engine compressors. More precisely, the present application concerns a system for controlling variable stator vanes. The present application also touches on an axial turbine engine, notably an aircraft turboreactor or an aircraft turboprop.

### 2. Description of Related Art

Certain turbine engine compressors include an annular row of variable stator vanes, also designated by the acronym “VSV” or “VSVs”. Said vanes have the special characteristic of pivoting 360° around their axes so well that their chord changes inclination with respect to the axis of rotation of the turbine engine. The deviation of flow produced by said vanes is thus able to be modulated. This allows for adaptation to different operating conditions of the turbine engine, and for improvement in the pumping margin. Said change in the orientation of the vanes can notably be effected by means of hydraulic cylinders.

Document FR 2914944 A1 discloses a gear system which includes control gearing for variable stator vanes which mesh with the additional gearing of an actuation ring. Said gears are toothed wheels, simplifying the prior operation and, thanks to the use of an electric motor, alleviating it so as to allow the orientation of the vanes. However, play can develop between the different parts of the gear resulting in a lack of rigidity in the structure as a whole.

Although great strides have been made in the area of turbine engine compressors, many shortcomings remain.

### DESCRIPTION OF THE DRAWINGS

FIG. 1 shows an axial turbine engine according to the present application.

FIG. 2 is a schematic representation of a portion of a turbine engine compressor of FIG. 1 according to the present application.

FIG. 3 shows the top end of a variable stator vane with the control gearings of FIGS. 1 and 2 according to the present application.

FIG. 4 is a schematic representation of a herringbone gearing according to a first embodiment of the present application.

FIG. 5 is a schematic representation of a herringbone gearing according to a second embodiment of the present application.

### DETAILED DESCRIPTION OF THE PREFERRED EMBODIMENT

The present application aims to resolve at least one of the problems posed by the prior art. More precisely, one purpose of the present application is to improve the rigidity of a system for controlling variable stator vanes. Another purpose of the present application is also to improve the stability of the control system. Finally, another purpose of the present application is also to propose a solution that is simple, resistant, light, economical, reliable and easy to produce.

One subject of the present application is a compressor for a variable-geometry turbine engine, in particular for a turboreactor, including: at least one annular row of variable stator vanes, each of the vanes comprising a control gearing, and an synchronizing ring with an additional control gearing, also knowns as corresponding gearing, which cooperates with the control gearing of the vanes so as to vary their orientation, remarkable in that at least one or each control gearing is a herringbone gearing, each herringbone including teeth which between them form an angle β of between 60° and 150° inclusive.

According to an advantageous embodiment of the present application, the teeth of the herringbone form between them an angle β of between 90° and 120° inclusive.

According to an advantageous embodiment of the present application, each tooth of the herringbone extends along a middle segment, the angle β being defined between the middle segments of a same chevron.

The two segments merge in the middle of the ring according to an angle β and form a herringbone. The gearing is composed of multiple herringbones which are oriented transversally with respect to the gearing.

According to an advantageous embodiment of the present application, the gearings of the vanes and of the synchronizing ring are configured so that each vane includes at least two or at least four herringbones simultaneously in contact with the ring.

According to an advantageous embodiment of the present application, the compressor additionally includes: an outer casing inside which the variable stator vanes are pivotably mounted, notably along a radial pivot axis.

According to an advantageous embodiment of the present application, each vane includes a spindle which traverses the outer casing in a radial manner, the outer casing preferably includes apertures which receive the spindles of the vanes so as to form pivoting connections.

According to an advantageous embodiment of the present application, the synchronizing ring is realized in metal, and the casing is realized in a composite material with organic matrix with carbon fibres and/or glass fibres.

According to an advantageous embodiment of the present application, the synchronizing ring forms a loop around the outer casing.

According to an advantageous embodiment of the present application, the variable stator vanes can have a spindle in their radially inner end, said spindle comprising a control gearing, engaged in the additional gearing of the synchronizing ring which is positioned in a loop around the inner casing.

According to an advantageous embodiment of the present application, the synchronizing ring is driven by at least one actuator, notably an electric motor.

The actuator can also be a hydraulic cylinder.

According to an advantageous embodiment of the present application, the control gearing of each vane includes at least 30 herringbones.

According to an advantageous embodiment of the present application, the additional gearing of the synchronizing ring includes at least 300 herringbones.

The control gearings and the additional gearings can include at least 40 herringbones, more preferably 50 herringbones.

According to an advantageous embodiment of the present application, each gearing forms a single-piece ring.

The advantage of single-piece gearings is that they are more resistant than normal gearings, due to the continuous character of the herringbones.

According to an advantageous embodiment of the present application, each gearing includes a central groove between the two teeth of the herringbones.

The central groove reduces the resistance of the gearing but facilitates the machining of the part.

According to an advantageous embodiment of the present application, each gearing is formed by two rings with oppositely orientated helices, the teeth of which merge at the centre.

Said design allows the machining to be made easier and reduces the axial displacement of the rings.

According to an advantageous embodiment of the present application, the compressor includes a stator and a rotor which is mounted so as to turn with respect to the stator, the variable stator vanes being fixed to the stator.

According to an advantageous embodiment of the present application, each vane includes an upstream half and a downstream half, each vane pivot axis being arranged in the upstream half.

According to an advantageous embodiment of the present application, the control gearing of each vane forms an angular segment, each angular vane segment extending at most over: 180°, or 120°, or 90°, or 60°, or 45°, or 30°.

According to an advantageous embodiment of the present application, each angular vane segment extends at most over: 10°, or 20°, or 30°, or 45°.

According to an advantageous embodiment of the present application, the synchronizing ring includes angular zones with herringbone gearing, and angular zones which are free of gearing and are arranged alternating with the zones with gearing.

According to an advantageous embodiment of the present application, the synchronizing ring includes one additional gearing or multiple additional gearings, each vane-controlling gearing being compatible with the additional gearing or one of the additional gearings of the ring.

According to an advantageous embodiment of the present application, each vane includes a main direction which is substantially inclined with respect to the radial direction, the herringbone circumferentially at the level of the vane, and/or the control gearing has teeth which form an angle of between 15° and 60° inclusive, preferably of between 30° and 45° inclusive, with the main direction of said vane.

According to an advantageous embodiment of the present application, each vane includes a leading edge and a trailing edge which are inclined with respect to the radial direction, the inclination of the leading edge and of the trailing edge with respect to the teeth of the gearing of the vane, and/or the teeth of the herringbone circumferentially at the level of the vane, being between 15° and 60° inclusive, preferably between 30° and 45° inclusive. An inclination equal to 0° corresponds to an angle of 0°.

Another purpose of the present application is a turbine engine, notably a turboreactor, including at least one compressor with a rotor; characterized in that the or at least one compressor is consistent with the present application, preferably the or at least one compressor is a low-pressure compressor or a high-pressure compressor, the turbine engine including the electric motor which is suitable to rotate the synchronizing ring.

In a general manner, the advantageous embodiments of each purpose of the present application are also applicable to the other purposes of the application. Each purpose of the present application is combinable with the other purposes, and the purposes of the present application are also combinable with the embodiments of the description, which are additionally combinable together, according to all possible technical combinations.

The measures of the present application are useful in that the form of the herringbone gearing limits the radial movement of the vanes with respect to the synchronizing ring. Thus, the synchronizing ring can be retained radially on the vanes by means of their gearings which remain engaged. In return, the ring contributes to retaining the vanes radially, and forms a strapping. Said retention is all the more efficient given that the ring forms a loop which is in contact with the entire annular row. More precisely, the ring retains a vane by means of another vane which is diametrically opposed, by means of their respective gearing.

Furthermore, the herringbone solution improves the blocking of the gearing, and limits the effect of vibrations as a herringbone provides a two-way action. The vibrations are damped by more friction. Also, the herringbone solution avoids tilting along the rotational axis between the vane and the ring. This allows the requirements in terms of retaining the vanes and the ring with respect to the casing to be reduced. Said effects become useful from a tooth inclination of between 60° and 150° inclusive, and is improved further between 90° and 120°.

In the following description the terms “inner” and “outer” refer to positioning with respect to the rotational axis of an axial turbine engine.

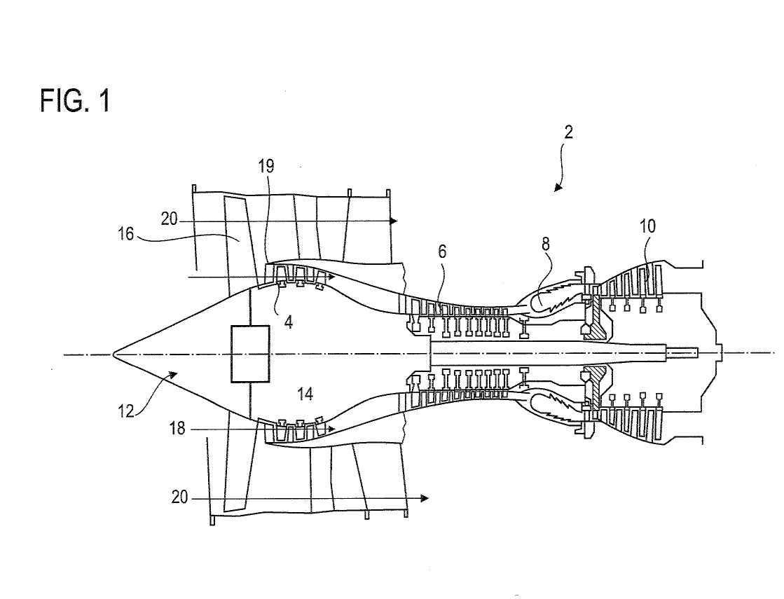

FIG. 1 shows an axial turbine engine 2 in a simplified manner. In this precise case, this is a double-flux turboreactor. The turboreactor 2 includes a first level of compression, a so-called low-pressure compressor 4, a second level of compression, a so-called high-pressure compressor 6, a combustion chamber 8 and one or multiple turbine levels 10. In operation, the mechanical power of the turbine 10 transmitted via the central shaft to the rotor 12 sets the two compressors 4 and 6 in motion. The latter comprise multiple rows of rotor vanes associated with rows of stator vanes. The rotation of the rotor 12 around its rotational axis 14 thus allows an airflow to be generated and the latter to be progressively compressed up to entry into the combustion chamber 8.

An intake ventilator, commonly designated fan or blower 16, is coupled to the rotor 12 and generates an airflow which is divided into a primary flow 18, which traverses the different levels of the turbine engine mentioned above, and into a secondary flow 20, which traverses a ring line (shown in part) the length of the machine to then merge with the primary flow 18 and leave the turbine.

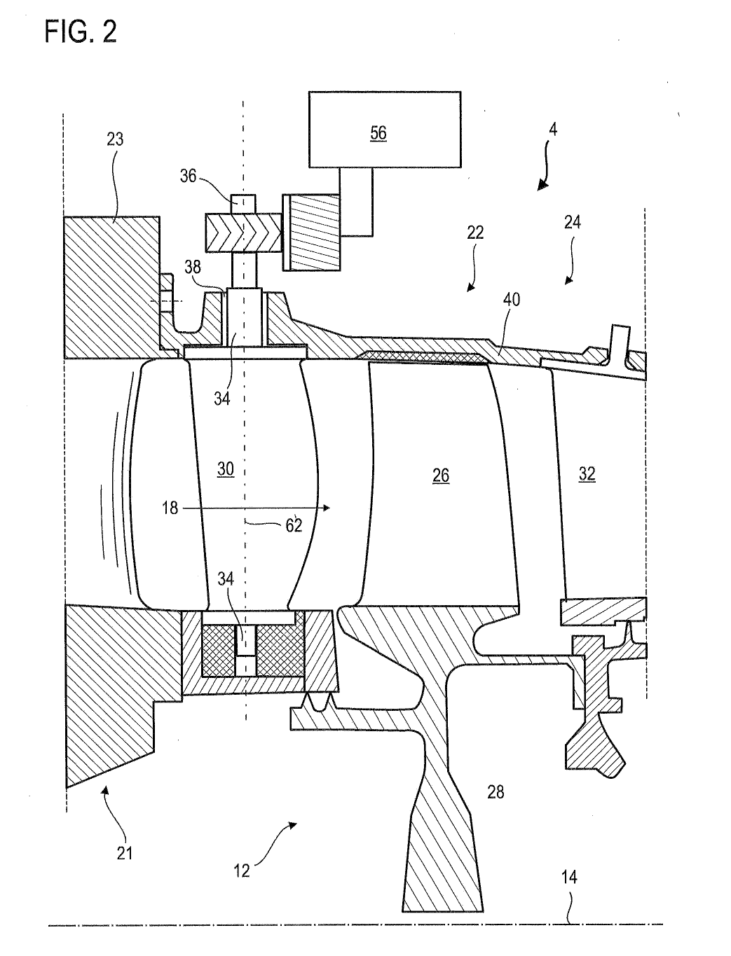

The secondary flow 20 can be accelerated so as to generate a thrust response. The primary 18 and secondary 20 flows are coaxial ring flows which are placed one inside the other. They are channeled by an outer casing 24 of the turbine engine 2. To this end, the casing 24 has cylindrical walls which can be inner and outer walls 40 (shown in FIG. 2).

The turbine engine can have a separation splitter 19, possibly de-icing. The separation splitter may be a circular splitter nose. The separation splitter 19 can divide the primary flow 18 from the secondary flow 20 in a circular manner.

FIG. 2 is a partial cross-sectional view of a compressor (4, 6) of an axial turbine engine such as that in FIG. 1. The compressor can be a low-pressure compressor 4. Part of the blower 16 and the rotor 12 including a row of rotor vanes 26 can be seen here. Said rotor vanes 26 are fixed to the rotor 12 by a supporting rim 28. To this end, the rotor can include a drum or a disc forming the supporting rim 28.

The low-pressure compressor 4 includes multiple straighteners which each contain a row of stator vanes (30; 32). The straighteners are associated with the fan 16 or with a row of rotor vanes 26 in order to straighten the primary airflow 18 so as to convert the velocity of the flow into pressure.

The compressor 4 includes a stator 22 which forms the straighteners. The compressor 4 includes multiple rows of vanes 32 which are connected to the stator 22, the vanes 30 of which are variable stator, also currently called “VSV” which is the acronym of the Anglo-Saxon expression “Variable Stator Vane”. Said orientable vanes 30 have chords which can tilt with respect to the rotational axis 14 of the compressor 4. Their top and bottom surfaces can more or less intercept the primary flow 18 in order to divert it according to different angles. As an option, the compressor 4 comprises an annular row of vanes 32 with fixed orientation with regard to the stator 22. Said fixed vanes 32 form a single-piece assembly with the casing 24. One single row of additional vanes 32 can be seen in FIG. 2, however it is conceivable to provide multiple rows.

The orientable vanes 30 extend substantially radially from the outer casing 24, and can be stabilized there by means of spindles 36. Said spindles 36 stabilize the ends of the vanes 30 in a suitable aperture 38 of the casing 24. Fixing the vanes 30 is made easier by the presence of journals 34 which are engaged in the inner shroud and form segments of spindle 36. Within a same row, the orientable vanes 30 are at regular spacings between one another, and are at a same angular orientation in the flow. In an advantageous manner, the vanes of a same row are identical. The casing can be formed from multiple rings, or of half-shells.

The turbine engine can include an intermediate casing 21 which supports the compressor 4, and/or an annular flange 23 belonging to the intermediate casing 21. The annular flange can possibly be a fixing flange of the stator 22, for example of the casing 24.

The teeth 50 of the herringbone 48, or double helical gear pair, can be opposite, axially, to the intermediate casing 21, or to the annular flange 23 or the separation splitter. They can possibly be turned axially toward the separation splitter, and be opposite one of said fixing zones.

The variable stator vane 30 includes a pivot axis 62 about which it pivots. The pivot axis 62 projects radially, it may be perpendicular to the rotation axis 14.

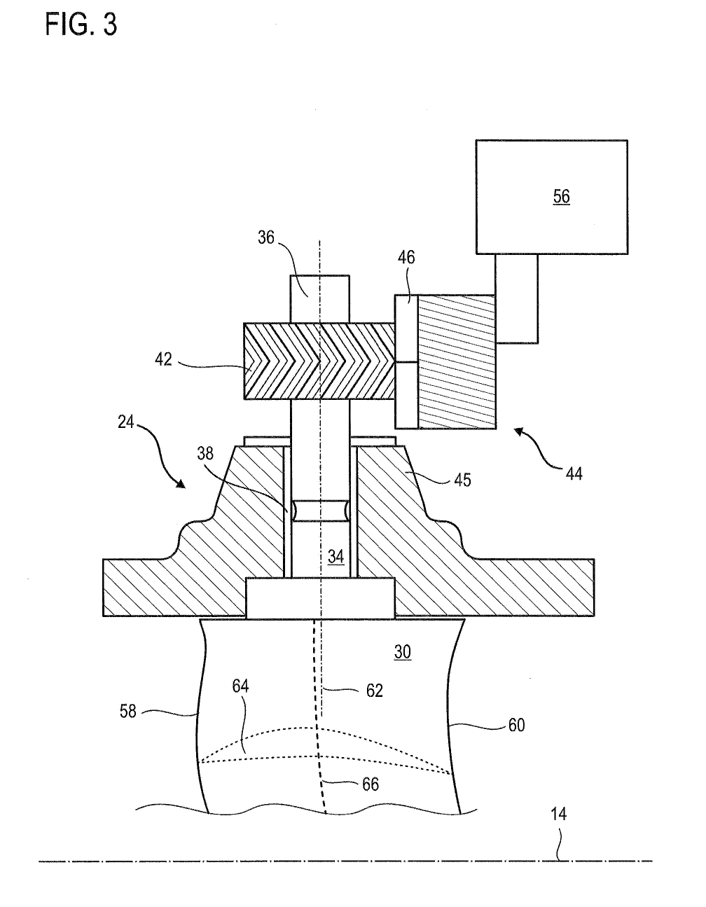

FIG. 3 shows a more precise view of the fixing of the orientable vane 30 on the outer casing 24. The spindle 36 of the vane which forms the journal 34, also known as trunnion, pressed into the aperture 38 of the outer casing 24 so as to traverse said latter in a radial manner, can be seen there.

A gear system according to the invention is situated in the top part of the spindle 36. Thus, the spindle 36 includes a control gearing 42, which is to be engaged in an additional gearing 46 positioned on an synchronizing ring 44. It is the rotating of the synchronizing ring 44 around the rotational axis 14 of the turbine engine which drives the rotation of the control gearing 42, and which will result in the 360° rotation of the vane 30. The driving of said elements can be effected by means of actuators 56, preferably one electric motor or electric motors so as to favour the overall simplification of the turbine engine. It is also possible to conceive of using more conventional systems, such as hydraulic cylinders, which are, furthermore, well known to the expert and are well described in the prior art.

The control gearing 42 can be formed by a sprocket connected to the spindle 36, or by a gearing machined in the spindle. The control gearing 42 is at a radial spacing from the casing 24, and notably from a boss 45 which forms an excess thickness in which the aperture 38 is formed. The ring 44 can also be at a radial spacing from the boss 45.

Although only one single orientable vane 30 is shown, it is conceivable for the present description to apply to the entire corresponding row of orientable vanes 30.

The leading edge 58 and the trailing edge 60 of the vane 30 have inclinations of between 20° and 60° inclusive with respect to the teeth of the control gearing 42. Spatially, the angle between the teeth and the leading edge 58 or the trailing edge 60 can be between 30° and 45° inclusive. A 0° angle would correspond to a configuration wherein the teeth are parallel to the leading edge 58 and to the trailing edge 60.

The variable stator vane 30 is formed by aerodynamic profiles 64, the aerodynamic profiles 64 are stacked generally radially so as to form the aerofoil of the vane 30. Each aerodynamic profile 64 is arranged in the annular flow, notably in the primary flow of the compressor. Consequently, each aerodynamic profile 64 is radially remote from the casing 24. These aerodynamic profile 64 each include a centre of gravity. The stacking of the centre of gravity draws a mean stacking curve 66. The mean stacking curve 66 differs from the leading edge 58 and from the trailing edge 60. The mean stacking curve 66 may be more smooth than the leading edge 58 and the trailing edge 60. It may be axially offset with respect to the pivot axis 62, for instance upstream.

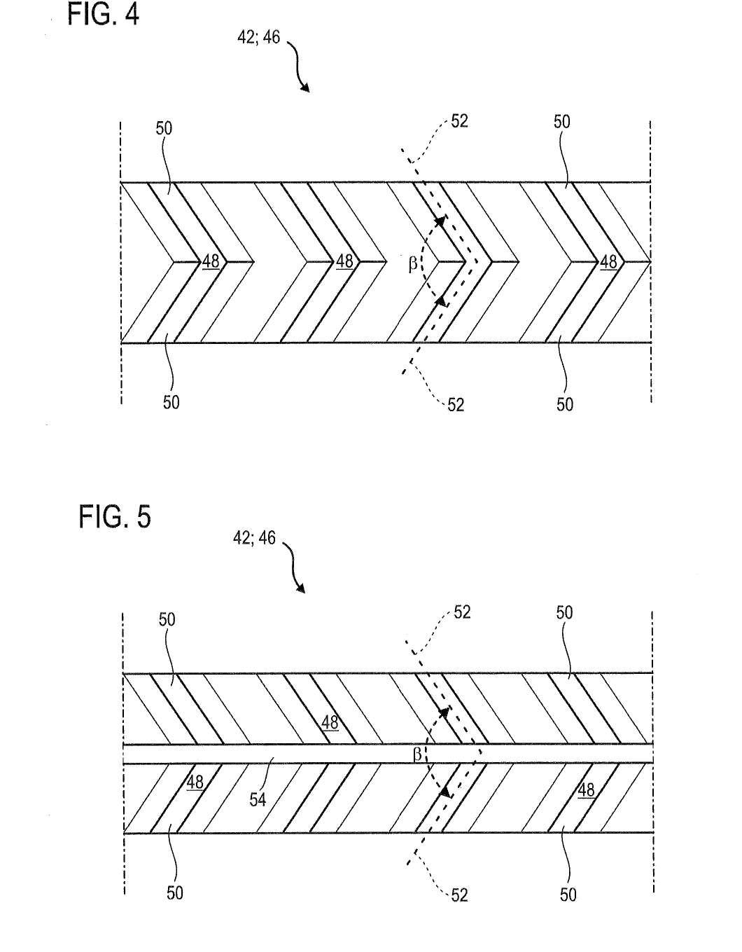

FIGS. 4 and 5 show flat elaborations of the gear teeth (42; 46) of the orientable vanes and of the synchronizing ring, the gear teeth being compatible.

The gear teeth (42; 46) form motifs which can be utilized on the sprockets or the rings being used as gears. More specifically, there are two herringbone motifs.

FIG. 4 shows a gearing (42; 46) according to a first embodiment of the invention.

The gearing (42; 46) repeats a motif in the form of a herringbone 48, said herringbone 48 comprising two teeth 50. The teeth 50 are angled with respect to one another.

Specifically, each tooth 50 extends according to a helicoid in space. Each tooth comprises a general axis or middle segment 52, which, when the two teeth merge in the middle of the ring, describes an angle β, preferably of between 60° and 150° inclusive, and more preferably of between 90° and 120°. The angle β can be a mean angle measured in space along the teeth 50.

Reducing the angle β tends to increase the number of herringbones 48 in contact simultaneously, which allows the number of gearing contact points, and therefore the friction that is useful for cushioning, to be increased. In addition, the reduction of the angle β allows the resultant radial mechanics inside the herringbone, and therefore the radial retention between the vane/synchronizing ring, to be increased. By contrast, increasing the angle β reduces the actuating forces when the orientations of the vanes are changed. Therefore, by means of the interval relating to the angle β, the invention provides a compromise which includes the actuating force.

The inclination between the mean stacking curve and the teeth being comprised between: 25° and 50°, inclusive; or between: 30° and 45°, inclusive. At least one tooth, notably the radially inner tooth, exhibits an inclination with the mean stacking curve which is comprised between: 25° and 50°, inclusive; or between 30° and 45°, inclusive.

Each tooth of the control gearing has an inclination comprise between: 15° and 60°, inclusive, with respect to the pivot axis; or between: 30° and 45°, inclusive.

FIG. 5 shows a gearing (42; 46) according to a second embodiment of the invention. Said FIG. 5 continues the numbering of the preceding figures for identical or similar elements. Specific numbers are utilized for elements that are specific to said embodiment.

It is also possible, and this is so as to facilitate the cutting of the herringbones 48 in the one-piece sprocket or from the one-piece ring, to conceive of providing a central groove 54 where the ends of the teeth 50 are facing. The central groove 54 cuts the herringbones 48 and the segments 50. It is also possible to provide two rings, each having a helical design, which are joined again at another time so as to obtain the sprocket as described earlier.

I claim:

1. A compressor for a turbine engine, comprising:
at least one annular row of variable stator vanes, each of the variable stator vanes comprising:
a control gearing; and
a synchronizing ring with an additional, control gearing which cooperates with the control gearings of the variable stator vanes so as to vary their orientation;
wherein at least one or each control gearing is a herringbone gearing, each herringbone including teeth which between them form an angle β of between 60° and 150° inclusive.

2. The compressor according to claim 1, wherein the teeth of the herringbone form between them an angle β of between 90° and 120° inclusive.

3. The compressor according to claim 1, wherein each tooth of the herringbone extends along a middle segment, the angle β being defined between the middle segments of a same herringbone.

4. The compressor according to claim 1, wherein gearings of the variable stator vanes and of the synchronizing ring are configured so that each variable stator vane includes at least two or at least four herringbones simultaneously in contact with the ring.

5. The compressor according to claim 1, wherein said compressor additionally includes an outer casing inside which the variable stator vanes are pivotably mounted, along a radial pivot axis.

6. The compressor according to claim 5, wherein each variable stator vane includes a spindle which traverses the outer casing in a radial manner, the outer casing preferably includes apertures which receive the spindles of the variable stator vanes so as to form pivoting connections.

7. The compressor according to claim 5, wherein the synchronizing ring is realized in metal, and the casing is realized in a composite material with organic matrix with carbon fibres and/or glass fibres.

8. The compressor according to claim 5, wherein the synchronizing ring forms a loop around the outer casing.

9. The compressor according to claim 1, wherein the synchronizing ring is driven by at least one actuator, notably an electric motor.

10. The compressor according to claim 1, wherein the control gearing of each variable stator vane includes at least 30 herringbones and the additional gearing of the synchronizing ring includes at least 300 herringbones.

11. The compressor according to claim 1, wherein each gearing forms a single-piece ring.

12. The compressor according to claim 1, wherein each of the control gearing and the additional control gearing includes a central groove between the two teeth of the herringbones.

13. The compressor according to claim 1, wherein the control gearing and the additional control gearing are each formed by two rings with oppositely orientated helices, the teeth of which merge at the center.

14. A turbine engine having an intermediate casing, an annular flange, a separation splitter, and a compressor with a rotor, the turbine engine comprising:
at least one annular row of variable stator vanes, each of the variable stator vanes comprising:
a control gearing;
a synchronizing ring with an additional control gearing which cooperates with the control gearings of the variable stator vanes so as to vary their orientations; and
an electric motor which is structurally and functionally adapted for rotating the synchronizing ring;
wherein the control gearing and the additional control gearing are herringbone gearings, each herringbone gearing including teeth which between them form an angle β of between 60° and 150° inclusive; and
wherein the teeth of the herringbone of the synchronizing ring being axially opposite the intermediate casing, the annular flange and the separation with respect to the teeth of the herringbone gearing of the variable stator vanes.

15. The turbine engine in accordance with claim 14, wherein the turbine engine is a turbojet engine.

16. The turbine engine in accordance with claim 14, wherein the compressor is a low pressure compressor with an inlet formed by the separation splitter.

17. A variable stator vane for a gas turbine engine, comprising:
a leading edge;
a trailing edge;
a radially inner end; and
a radially outer end including a journal with a pivot axis about which the variable stator vane pivots in order to vary the orientation thereof with respect to a flow of the turbine engine, the journal comprising:
a control gearing which is a herringbone gearing, each herringbone gearing including teeth which between them form an angle β of between 60° and 150°, inclusive.

18. The variable stator vane in accordance with claim 17, wherein each tooth of the control gearing has an inclination between 15° and 60°, inclusive, with respect to the pivot axis.

19. The variable stator vane in accordance with claim 17, wherein the teeth of the control gearing have inclinations of between 20° and 60°, inclusive, with respect to the leading edge and to the trailing edge.

20. The variable stator vane in accordance with claim 17, wherein the variable stator vane includes a mean stacking curve, the inclination between the mean stacking curve and the teeth being between 25° and 50°, inclusive.
